(19) United States
(12) Patent Application Publication
(10) Pub. No.: US 2002/0194014 A1
(43) Pub. Date: Dec. 19, 2002

(54) Legal and regulatory compliance program and legal resource database architecture

(76) Inventors: Curt R. Starnes, Overland Park, KS (US); Joan R. Ruff, Kansas City, MO (US); Sherry L. Jenkins, Boston, MA (US)

Correspondence Address: Blackwell Sanders Peper Martin LLP, 40 Corporate Woods, Suite 1200, 9401 Indian Creek Parkway, Overland Park, KS, 66210, US

(21) Appl. No.: 10/126,646

(22) Filed: Apr. 19, 2002

Related U.S. Application Data
(63) Continuation-in-part of application No. 09/552,235, filed on Apr. 19, 2000.
(60) Provisional application No. 60/284,916, filed on Apr. 19, 2001.

(51) Int. Cl. G06F 17/60

(52) U.S. Cl. 705/1

(57) ABSTRACT

A distributed risk management system, computer program, and method are provided that together provide a comprehensive source of risk management and compliance information that permits businesses to more effectively manage risks associated with business activities. The invention permits businesses to identify potential liabilities, evaluate current procedures in dealing with such risks, implement recommended risk management procedures, and validate that the recommended procedures have in fact been implemented and are effective.

This application is a continuation-in-part of U.S. patent application Ser. No. 09/552,235 filed Apr. 19, 2000. This application also claims benefit of provisional application Ser. No. 60/284,916, filed Apr. 19, 2001.

### BACKGROUND OF THE INVENTION

Today's businesses face increased legal and economic liabilities for activities that may be unlawful or otherwise out of compliance with laws and regulations. For example, more and more businesses are being sued and/or fined for discriminatory hiring and firing, work-related sexual harassment, environmental infractions, work-related personal injuries, and other activities that may be in violation of laws or governmental regulations. As these lawsuits continue to proliferate, several trends are emerging. One trend is that relatively minor infractions are becoming the basis for lawsuits. Another is that courts are looking more at employers' responses to infractions rather than the seriousness of the infractions themselves when assessing liability and damages. Both businesses and their insurers suffer financial harm from non-compliant workplace activities through the loss of business reputation, higher insurance premiums, higher claim coverage costs, increased legal fees, and decreased employee morale.

Compliance program concepts trace their roots to programs begun in the defense industry in the 1970's in response to various problems. The government required that any company doing defense business with the government had to have a compliance program, which meant that they had to establish business standards, (prohibitions on conflicts of interest, etc.), had to communicate and train employees on these standards, had to audit for compliance with the standards and, finally, had to have a method to investigate and fix suspected or real breaches of the business standards.

Later, in 1991, the federal sentencing guidelines gave benefits in the form of reduced fines and penalties to corporations if a corporation, though found liable, nevertheless had an “effective compliance program.” Effectiveness is not conditioned upon never having a violation, and the presence of a compliance program is considered an important factor.

In 1999, the U.S. Justice Department put out a memorandum that encouraged U.S. Attorneys to consider compliance programs in deciding whether to charge companies with a federal crime. Lately, punitive damage case law relating to sexual harassment, antitrust amnesty cases, Federal Acquisition Regulations relating as to who can qualify as a federal contractor, avoiding Occupational Safety and Health Administration (“OSHA”) and Environmental Protection Agency (“EPA”) liability through self-correction of violations, and Health and Human Services (“HHS”) Guidelines for nursing facilities and physician practices, have helped fuel developments in this area.

In addition to these “substantive” areas, the general theory of reputation as capital has lead to several business school studies trying to measure “reputational capital” and offering case studies comparing companies that have acted to protect their reputation to those who have failed.

Many sources of information are available to help businesses manage workplace risks in the compliance context. However, existing sources typically provide only limited information that is often out of date and too generalized to be useful to a particular business. Therefore, most businesses currently merely react to workplace liabilities by contacting their insurer and/or attorney after receiving a complaint or being sued rather than proactively attempting to eliminate or reduce such liabilities before they occur. Unfortunately, little can be done to reduce possible liabilities and to rectify past non-compliant activities in such a reactionary manner.

### SUMMARY OF THE INVENTION

The present invention solves the above-described problems and provides a distinct advance in the fields of insurance underwriting, risk management, and regulatory and legal compliance. More particularly, the present invention consists of a web-based risk management system, computer program, and method that together provide a comprehensive, on-line source of risk management and, compliance information that permits businesses to proactively manage risks associated with business activities.

A computer program is provided including instructions that are operable to access a database of information relating to loss prevention issues. Instructions are also provided that permit a plurality of users to access the host computer via a communications network, permit the users to request information relating to loss prevention issues, and that respond to information requests by accessing the database to locate the requested information. Further, instructions are provided that administer a test to a user, the test including test questions relating to loss prevention issues. Additionally there are instructions that access correct answers to the test questions and compare the answers given by the user to the correct answers. Recommended procedures are identified, the procedures relating to each of the test questions. Users are also optionally provided with the recommended procedures.

Optionally, the loss prevention issues include at least one of the following: sexual harassment issues, discriminatory hiring and firing issues, environmental issues, workplace safety issues, disability issues, tax issues, antitrust issues, securities issues, insider trading issues, hazardous materials issues, truth-in-lending issues, personal injury issues, and officer/director liability issues. Instructions operable to receive verification from the user that the user has implemented the recommended procedures are optionally provided. Further, instructions operable to track which users have taken the test, test results for each of the users, and whether each of the users has implemented the recommended procedures, and to generate tracking information relating are also optionally provided.

In one embodiment, the information stored in the database includes at least one of the following: loss prevention articles, frequently asked questions, loss prevention standards, loss prevention best practices, applicable laws, and loss prevention tips.

In an alternative embodiment, the level of compliance understanding is evaluated by compliance personnel designated by a chief compliance officer who is designated by a corporate board of directors. The compliance personnel responsible for compliance evaluations have sufficient organizational freedom to identify and evaluate law compliance problems and to initiate, recommend, or provide solutions to any of the law compliance problems.

### BRIEF DESCRIPTION OF DRAWINGS

Exemplary embodiments of the present invention are described in detail below with reference to the attached drawing figures, wherein:

FIG. 1A is a schematic diagram of a web-based risk management system constructed in accordance with an embodiment of the present invention;

FIG. 1B is a schematic flow diagram of a web-based risk management system constructed in accordance with an embodiment of the present invention;

FIG. 2 is a schematic block diagram illustrating an interrelationship between modules of a risk management system consistent with the present invention;

FIG. 3 is a schematic block diagram illustrating modes of operation of a system manager consistent with the present invention;

FIG. 4 is a schematic block diagram illustrating types of information associated with documents managed by a document manager consistent with the present invention;

FIG. 5 is a schematic block diagram illustrating connections between a risk management system and external information providers and information receivers; and

FIG. 6 is a schematic diagram of an exemplary user interface that is operable to receive information regarding documents.

### DETAILED DESCRIPTION

The present invention involves several components, including risk management system 10, which includes client computers 14 that communicate over network 16 to host computer 12. Risk management system 210 includes several modules that are used by businesses to provide compliance knowledge and understanding to their users. Further, the risk management system 210 can be used to verify that users have mastered an appropriate amount of compliance information. A system manager 310 is used to configure and provide administrative functions in connection with the risk management system 210. Additionally, a document manager 410 is used to insert document information into databases associated with the risk management system 210.

In one embodiment, a web-based risk management system is provided that can be tailored to industry, location, customer, and individual specifications. The risk management system integrates a relational database, documentation and diagnostic tools, on-line training, and consulting together with content authoring tools for customization of the risk management system.

In this embodiment, the risk management system can be accessed from various locations (i.e. corporate offices, remote sites, mobile users). Accordingly, multi-culture, and multi-language support is also provided. The content corresponding to the risk management system is located in various sources, such as data providers, database servers, and web sites associated with the risk management system.

In one embodiment, customers and users of the risk management system have proprietary on-line training systems that integrate with the risk management system. To facilitate this integration, a demonstration risk management system is provided. In one embodiment, services are provided in connection with a risk management system consistent with the present invention using Microsoft based technology, including the Microsoft Windows NT operating system, the Microsoft SQL (“Structured Query Language”) Server relational database server system, and the Internet Information Server (“IIS”). It is understood that other equivalent products, from other vendors or sources, could be employed without departing from the scope of the invention.

In one embodiment, users connect to and operate on the risk management system using Netscape Navigator and Internet Explorer. In this embodiment, the risk management system supports the current versions of the most popular standard browsers as well as, for example, future browser versions, including future versions that are backward compatible.

One embodiment of the present invention involves an on-line web-based risk management system comprising a host computer that may be accessed by a plurality of user computers via a communications network such as the Internet. The host computer is configured to store or access at least one database of information relating to loss prevention issues. Users may access the host computer via the communications network and view and/or download information from the database to help them identify, evaluate, and manage risks associated with business activities.

In accordance with one aspect of the present invention, the host computer is configured to administer tests relating to loss prevention issues. Users may access the host computer and take a test while on-line and then receive a test score based on the answers. The host computer determines which of the test questions were answered incorrectly, and in response, provides recommended procedures that relate to the incorrectly answered questions. The users may then implement the recommended procedures to rectify non-compliant business practices within their organization.

The host computer preferably tracks which users have accessed information from the site, which users have taken tests, the test results for the users, and whether users have implemented the recommended procedures. This permits an operator or administrator of the host computer to maintain an audit trail of use of the host computer for validation purposes.

The present invention provides numerous benefits not provided by prior systems. For example, the present invention provides a single, comprehensive, on-line source of risk management and compliance information that may be accessed by users to more effectively manage compliance risks associated with business activities. The invention permits businesses to identify potential liabilities, evaluate their current procedures in dealing with such risks, implement recommended risk management procedures, and validate that the recommended procedures have in fact been implemented and are effective. Use of the present invention helps organizations provide a safer and more friendly workplace free of non-compliant activities, resulting in an improved business reputation, lower insurance premiums, lower claim coverage costs, decreased legal fees, and higher employee morale.

In one embodiment, general standards for compliance program administration include a group of factors. Responsibility and authority is clearly established for carrying out activities that are necessary for law compliance. Corporate directors designate at least one senior manager, who is responsible for the law compliance performance of an enterprise. Directors also designate a chief compliance officer. Alternatively, directors may appoint a risk management committee. In one embodiment, board members also periodically inquire about law compliance problems that may be occurring within the enterprise. Based on the inquiry, board members may change managerial control over compliance performance, in the case that satisfactory results are not being achieved.

Compliance program responsibilities are articulated in terms that both system participants and program evaluators can understand and use to measure the adequacy of related actions. System participants include those persons that utilize the compliance system to ensure business operations are compliant and evaluators include those persons that evaluate or audit the participation of system participants.

The authority held by parties who are responsible for specific aspects of law compliance is sufficient to control all the actions and resources necessary to achieve compliance. Personnel responsible for compliance evaluations have sufficient organizational freedom to identify and evaluate law compliance problems and to initiate, recommend, or provide solutions. Where compliance requires the coordination of several types of employee activities, responsibility and authority to control the necessary interactions is assigned to clearly identified individuals. The responsibilities of corporate managers to oversee law compliance in operations under their control is delegated to subordinates in exceptional circumstances and the subordinates receiving these delegated responsibilities are independent of the parties scrutinized. High-level corporate managers regularly review the operation and sufficiency of a company's compliance mechanisms.

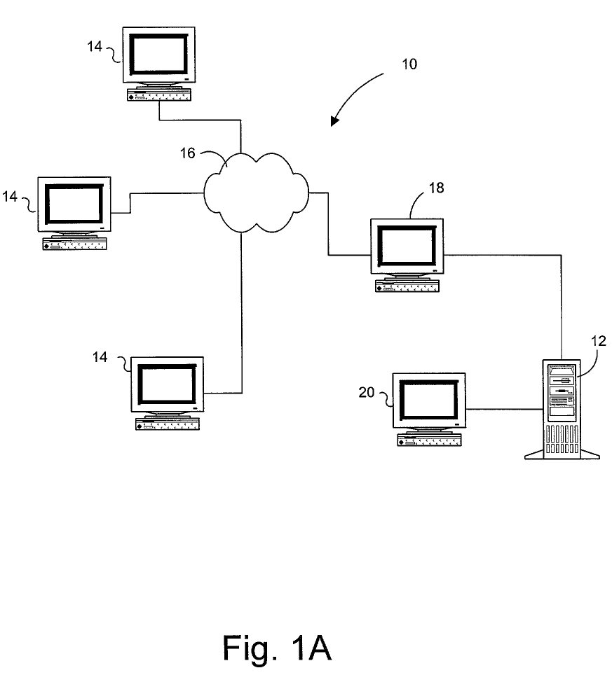

Regarding FIG. 1, a distributed risk management system 10 in accordance with one embodiment of the present invention is illustrated. The system broadly includes a host computer 12 that is coupled with a plurality of user computers 14 by a communications network 16.

In one embodiment, the host computer 12 serves as a web hosting computer and may be accessed by users operating the user computers 14 via the network 16. The host computer may be any conventional computing device such as a network computer running Windows NT, Novell Net Ware, Unix, or other network operating system. The host computer preferably includes conventional web server software, such as for example the Apache web server available from the Apache Software Foundation or the Internet Information Server (“IIS”) from Microsoft Corporation. In one embodiment, host computer 12 includes an Internet connection such as a modem, DSL (“Digital Subscriber Line”) converter, ISDN (“Integrated Services Digital Network”) converter, or other type of network interface. Host computer 12 is also assigned a domain name such as, for example, “universalriskmanager.com” so that it can be accessed via the Internet in a conventional manner.

The host computer is optionally connected to a computer 18 that serves as a firewall to prevent tampering with information stored on or accessible by the host computer. The host computer may also be connected to a computer 20 by a local area network or other network to permit an administrator to configure and service the host computer.

The user computers 14 can be any type of conventional computing devices such as personal computers sold by Dell, Compaq, Gateway, or other computer manufacturers. Each user computer preferably includes a conventional Internet connection such as a modem, DSL converter, ISDN converter, or other type of network interface and a web browser that permits it to access the Internet via the communications network. The communications network may be the Internet, a local area network, a wide area network, an intranet, an extranet, or any other data network.

The host computer 12 includes or can access internal and/or external memory that stores a plurality of databases containing information related to risk management and regulatory and legal compliance issues. In one embodiment, the databases include: a library of applicable laws and regulations; best practice solutions to particular business activities; frequently asked questions and answers; articles on loss prevention written by industry experts; real-time notifications of recent developments in the fields of insurance underwriting, risk management, regulatory and legal compliance; and other information that can be used by business owners to identify, address, and manage risks associated with business activities. The databases are preferably SQL databases with synchronization.

The information in the databases may include information on topics such as recruitment and hiring, workforce decision-making, salaries, wages and hours, employee benefits, mandated leave, withholding and documentation, harassment policies, workplace safety, accommodation of the disabled, notices and postings, employee handbook/code of business conduct, disclosure, internal investigation, training, personnel and manager training, entity formation, authority to do business, meetings, officer and employee authority, officer/director liability, tax, anti-trust securities and insider-trading, foreign corrupt practices act, business practices, requests for information, candor and cooperation with governmental officials, and corporate investigations.

The web-based risk management system 10 may be used to provide risk management information to any type of business. In one embodiment, the system provides risk management information to franchised auto dealers. In another embodiment, the risk management system 10 is used internally by an insurance company.

A user may access the web site in a variety of ways. For example, a user operating one of the user computers 14 may access the home page of an insurance underwriter such as Universal Underwriters Insurance Corporation. The user is then asked to log in by entering a password or code. The host computer then displays a home page for the risk management system of the present invention. Users can also access the home page directly without first accessing the insurance provider's home page.

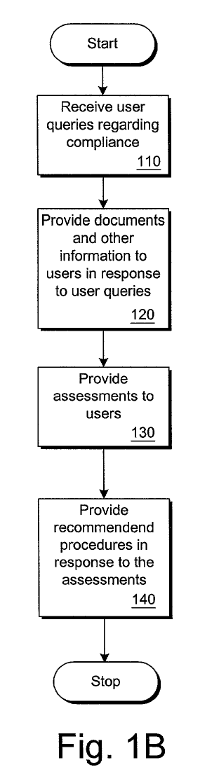

FIG. 2 is a schematic block diagram illustrating an interrelationship between modules of a risk management system consistent with the present invention. Risk management system 210 is used to organize information related to laws, regulations, and standards associated with administration, management, or operation of various organizations. In one embodiment various discrete modules are associated with compliance system 210. Specifically, the professor module 220 is made available to users of compliance system 210 to provide computer based or on-line training to users of the compliance system.

### Professor

The professor module 220 is provided as an on-line training management system. Links from on-line training course catalogs are provided to potential training participants. Courses are mapped to specific standards and displayed in connection with a risk management system consistent with the present invention.

In one embodiment, the professor module is accessed in various ways from a web-based risk management system. A link into an on-line training platform is selected from the main risk management system page if the professor icon is selected. Additionally, a link into on-line training course materials is provided if a specific course is selected by a user of the risk management system. Further, risk management system users have the ability to connect to other on-line training platforms as necessary or desired. Web-enabled training courses are linked to standards, laws and regulations, and best practices as defined in connection with other portions of the risk management system.

In one embodiment, a professor module corresponding to a risk management system consistent with the present invention includes: (i) an on-line training platform; (ii) a training course catalog; and (iii) training transcripts, which, analogous to educational institutional transcripts contain information regarding coursework performed by a trainee, including, for example, scores on tests or assessments.

Referring now to FIG. 1B, a schematic flow diagram of a web-based risk management system is provided. At stage 110, user queries regarding compliance issues are received. In response to the user queries, documents and other information is provided to users, the documents and other information being relevant to the user queries (stage 120). Next, users are provided assessments to determine the level of their compliance knowledge or understanding (stage 130). Additionally, in response to answers provided by the users in connection with the assessments, recommended procedures are provided that are suited to furthering compliance goals of the user's organization (140).

### Librarian

Referring back to FIG. 2, in addition to the professor module 220, the risk management system 210 includes a librarian module 230. The librarian module 230 includes several components. These include (i) general compliance, which relates to general laws and regulations common to a diverse group of business entities; (ii) corporate operations, which are compliance issues relating to the operations of a corporation; (iii) employment issues, which relate to employment related compliance issues; (iv) environmental compliance issues, (v) workplace safety related compliance issues; and (vi) other compliance components as desired or necessary, such as industry-specific compliance issues, for example insurance, technology, construction, and automotive industry related issues. Using the librarian module, users can search for and use particular documents that are relevant to the above-identified issues.

### Manager

In connection with the risk management system, a manager module 240 is provided, which provides measurement, assessments, certification and project management functionality. Specific elements of the manager module include: (i) individual tests; (ii) a self-assessment tool to provide an indication of an individual's current compliance training level; (iii) an improvement plan, including links to the professor and librarian modules; (iv) compliance auditing tools; (v) independent assessment; and (vi) corrective action planning.

The manager module also contains a compliance calendar having the ability to facilitate maintenance of compliance schedules. Compliance schedules are timetables for implementing programs to remedy current or potential compliance problems or timetables to meet newly enacted standards. Schedules are established and maintained at varying levels such as at the level of a compliance officer, or similar centralized position, at the level of a particular department, or at the level of a specific employee. In one embodiment, dates are automatically associated with data structures corresponding to the compliance calendar. In this embodiment, the dates are identified based on information contained in risk management system documents, such as a future compliance date for recently passed regulation, when a document associated with the legislation becomes a part of the risk management system's databases.

Links are provided to calendar details, laws, standards, policies, procedures. In one embodiment, customized calendar functionality is based on a corporate profile. The compliance calendar associated with the manager module is capable of being integrated with E-mail and calendar systems such as Lotus Notes available from the International Business Machines Corporation or Microsoft Outlook, available from the Microsoft Corporation. In one embodiment, alarms are provided that are associated with due dates for specific compliance activities. In another embodiment, the ability to view the calendar of other users is provided.

Associated with the manager module of the risk management system is also the project manager sub-module 242. In connection with the project manager, an appropriately authorized user has the ability to assign rights to others and exercise oversight responsibility.

The project manager portion of the manager module facilitates documentation of steps taken to address a compliance issue. In one embodiment, this documentation is recorded and formatted similarly to a project plan as created in connection with the Microsoft Project software package. In another embodiment, the documentation is less complex than a typical Microsoft Project plan. The project manager also facilitates task assignment and acknowledgement of receipt of assignment, which, in one embodiment, is implemented using E-mail software return receipt functionality. The project manager portion also provides the ability for an appropriately authorized user to view the task list of other users. Finally, dates from the project manager portion are applied to or associated with the compliance calendar

The manager module of the risk management system also allows the risk management system to be used to verify that users are appropriately trained in predetermined compliance areas. Specifically, the management module is used to ensure that necessary personnel are adequately familiar with certain standards. This verification is accomplished by providing an assessment of standards knowledge to an appropriate group of employees.

The assessment can be applied on an individual level or based on a role or user group to which a particular user is assigned. Further, assessments can be mandated, which means they are required by a superior, within the organization, or by a third party with authority to require performing the assessment. Mandated assessments need to be completed according to a specific schedule. Alternatively, assessments can be self-initiated, meaning they are performed based on an individual's own initiative.

Assessments fall into at least two groups including original assessments, which are used to find potential problem areas in terms of compliance, and follow-up assessments. Follow-up assessments optionally include versions, which are revised or different questions designed to test the same area of knowledge. The follow-up assessments are used to ensure that once a compliance problem is identified, it is properly remedied and appropriate persons are sufficiently well-trained regarding the compliance issue. Assessments are generated based on standard and customized templates, which include templates provided by a risk management system provider and that can be modified or prepared specifically by a user of a risk management system, for example a user to whom the task was assigned by a chief compliance officer. Core templates are associated with the base risk management system as provided by the risk management system operator. The core templates include questions designed to test for knowledge of generally applicable compliance issues. Other templates include industry targeted templates and templates involving customized or third party requirements. In one embodiment, certain components of the template are static and, therefore, not customizable by a user of a risk management system.

In one embodiment, assessment templates comprise groups of pre-defined questions. The groups of predefined questions are associated with individual documents that have a unique document type and that are linked to one or more standards. In one embodiment, weights are assigned to specific assessment questions, such that certain assessment questions can be given more importance than others. In one embodiment, assessments have a numeric or percentage score that includes any associated weighting of the questions. Assessments are customizable, meaning risk management system administrators have the ability to add, change, or delete questions.

In one embodiment assessments are provided in connection with independent verifications or third party audits of compliance educational and training procedures. In this embodiment, an assessment user interface has the ability to receive comments related to standards. Assessments are provided at varying levels up to and including assessments directed to the primary organizational entity, such as the corporate entity through the officers or board of directors. Results of assessments are aggregated to provide summary information broken down at levels, such as at the department or business unit level.

Administrators of the risk management system have an ability to transmit mandated assessments which include a notification to a person that the person is required to take part in an assessment. Managers have the ability to mandate assessments for departments or individuals. Further, the corporate compliance officer or other senior manager has the ability to mandate assessments. In one embodiment, the risk management system sends a request to a manager who then forwards an assignment or specific instructions to perform a particular assessment to the appropriate employees. Managers have the ability to create assessments or modify existing assessments and assign specified assessments to particular individuals for completion of the specified assessments.

In one embodiment, the manager module generates and sends an automated E-mail notification that an assessment is being assigned, including a Uniform Resource Locator (“URL”) or other type of link, which an individual may select to answer questions corresponding to the assessment. Optionally, a compliance assessment can be provided to independent contractors that are required to achieve satisfactory performance levels on the assessment as a term of their contract.

Managers associated with the risk management system have the ability to track completion of assessments and review employees' results. In connection with tracking and reviewing assessments, the assessment portion of the manager module sends early alerts to managers, the alerts corresponding to specified problem areas identified in the assessments. For example, multiple assessments within a group, such as a department, may identify misunderstanding or lack of adequate training with regard to a particular compliance issue, so that trends can be identified even before all assessments are completed, and ideally before an actual non-compliant incident occurs. Based on identified compliance problem areas, compliance training may be performed or other remedial actions taken.

Results of assessments are handled in various ways. Individual, self-initiated assessments are stored for a predetermined number of days and can be discarded after that number of days elapses. In one embodiment, assessments are provided to an assessment evaluator, such as a manager or auditor, within this timeframe only. Assessments can be saved as drafts to be revised or reviewed by the user only. A user performing an assessment has the ability to bookmark a location associated with the assessment, when performing an assessment. In this way, if an assessment is interrupted it can be resumed and completed at a later time.

Similarly, mandated assessments are saved for a predetermined number of days. In one embodiment, the association retention period varies based on the type of assessment. An assessment is saved by a particular assessment participant. Upon completion of an assessment, notification is sent to the person who initiated the assessment. In one embodiment, the notification is sent with results and percent of correct or compliant answers to be provided in a summary view. Based on the summary view, a requester has the ability to then, if desired, drill down into detail within the separate sections of the relevant assessment.

In one embodiment, a participant in a self-initiated assessment is presented with the opportunity to discard the results of the self-initiated assessment. In this way, users are encouraged to learn correct answers to compliance issues, without concern that incorrect answers will cause problems for the user. Appropriately authorized users of the risk management system have the ability to print and display results of assessments via an online interface.

In one embodiment, the manager module also contains an improvement plan 244 portion. The improvement plan portion includes various links to resources for specific improvement plans and corrective actions that may be taken in response to issues identified by way of assessments. Further, links to specific training courses are provided. Additionally, specific documents are identified for review and analysis so that a possible procedural or workflow defects can be identified. In one embodiment other optional links are included, for example links to outside sources of information, such as OSHA.

Additionally, the manager module provides an ability to add action items and track compliance progress. If a user performing an assessment failed to achieve a certain score, it can be determined that he or she needs an improvement plan and/or associated corrective action. In one embodiment, the manager module includes notification and escalation procedures corresponding to situations in which users are not performing assessments or taking part in improvement plans or corrective action plans.

### Consultant

In addition to the professor module 220, librarian module 230, and manager module 240, a consultant module 250 is provided. The consultant module 250 involves various elements. There is an on-line customer specific consulting module, which provides consulting information to users based on individualized parameters. In the consultant module, an interface is provided that provides on-line question and information retrieval/resource direction. Further, a toll-free telephone number provides a services allowing employees to report issues, concerns or violations from within the user's employer. The consultant provides an interface to an industry-specific legal preferred provider organization (“PPO”) network, meaning the consultant can provide a framework to offer users legal services through available resources analogously to other types of PPO.

In order to provide a more flexible interface to the compliance authorities database, the consultant module provides a natural language search interface into the risk management system databases, allowing natural language type questions to be provided to a search engine. For example, “what is the Illinois tort statute of limitations regarding negligence?”

The consultant module also contains an on-line compliance response center, including various elements. The resource center supports various on-line consulting features including a technical help desk to assist users with specific aspects of using the risk management system.

In one embodiment, the resource center is customized by a user into an on-line personalized consulting program. Through the process of personalization, organizational consulting elements, activities, and services provided by a risk management system operator is customized in order to engage a customer.

Templates are documents defined in the system that provide a framework or starting point. In one embodiment, a templates component is provided only to customers who purchase the templates consulting service.

### System Manager

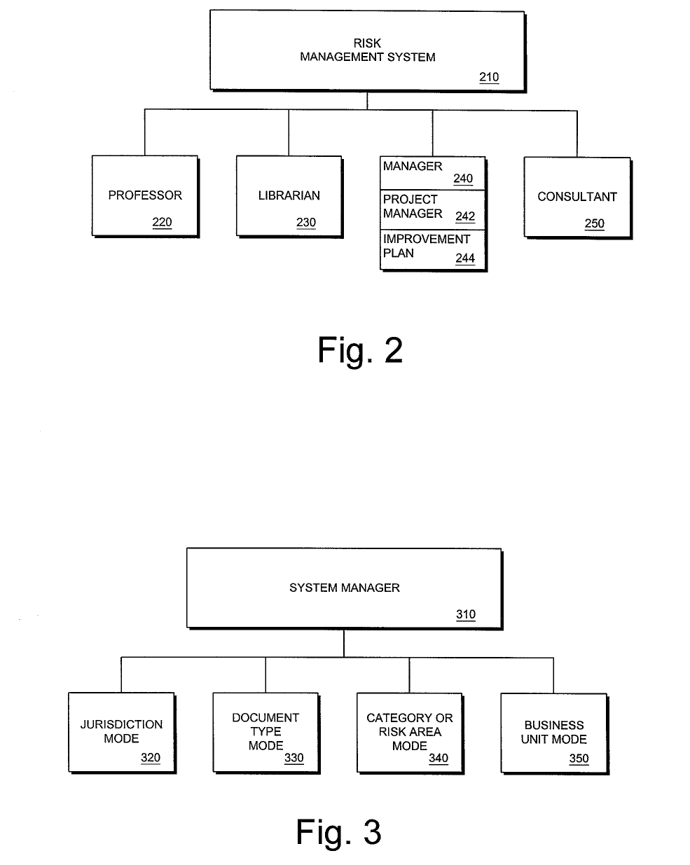

FIG. 3 is a schematic block diagram illustrating modes of operation of a system manager 310 consistent with the present invention. The system manager 310 is used to edit the data-driven application data tables of risk management system 210. A data-driven application is an application, the operation of which can be modified by changing data rather than changing a program associated with the application. Associated information is received using various modes: jurisdiction mode 320, document types mode 330, categories mode 340, and business units mode 350. The system manager 310 facilitates initial system configuration and ongoing maintenance of risk management system 210. The system manager 310 is used to establish categories that can be used as search criteria, which allow a user to retrieve documents based on search parameters. The system manager 310 allows entry of documents into databases associated with the risk management system 210. The system manager 310 is used by designated individuals to edit and maintain the data driven tables that support the searching capabilities of the risk management system 210.

Jurisdictions, corresponding to the jurisdiction mode 320, correspond generally to geographical regions and more specifically to the territorial range of authority of various governments, courts, or agencies. Document types corresponding to the document type mode 330 correspond to an identification of different types of compliance-related publications and summaries. Categories and risk areas corresponding to the category mode 340 correspond to a grouping of compliance items based on specifically-characterized risk areas. Business units corresponding to the business unit mode 250 are used to group users based on functional units within an organization.

Within the system manager 310, the jurisdictions mode 320 is used to add, edit, or delete a jurisdiction. Once available, a jurisdiction can be associated with a specific business unit. Further, jurisdictions may be associated with specific document types. Within jurisdictions, parent and child jurisdiction relationships can be established. For example, a parent jurisdiction of “United States of America” has the child jurisdiction of “Alabama.”

The document types mode 330 is used to add, edit, or delete document types. A user group may be associated with a particular document type. Example document types include: case law summaries, news flashes, and business standards.

The categories mode 340 is used to add, edit, or delete a category or risk area. In one embodiment risk areas associated with an arbitrary activity are associated with a category. Example categories include: General Corporate, Employment, and Food Safety. Within the categories, specific risk areas are also identified.

The business unit mode 350 is used to add, edit or delete business units. In the business units mode 350, a dialog box is used to receive user input regarding actions to take in connection with the business unit mode 350. In one embodiment, the business unit mode dialog box has three tabs for providing the following functions. The first tab, entitled General, allows an ability to add a new business unit or to edit an existing business unit. The second tab, entitled user groups, is provided to allow adding a new user group or to assign permissions to an existing user group. Finally, the third button, entitled jurisdictions, is used to assign jurisdictions to a business unit.

### Document Manager

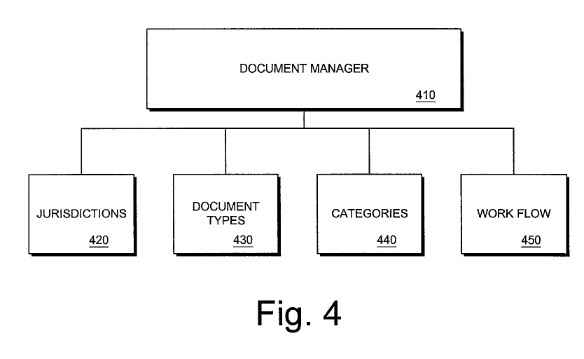

FIG. 4 is a schematic block diagram illustrating types of information managed by a document manager consistent with the present invention. The document manager is another software component of a distributed risk management system. The document management software allows operators of the risk management system to add information into databases associated with the risk management system. For example, recent legal decisions are summarized and saved into a legal decisions database. The summarized decisions may then be used to provide information to users regarding changes in the law regarding aspects of complying with various laws and regulations.

The document manager module populates the compliance system databases. The document manager is used to: (i) create new documents; (ii) edit existing documents; (iii) link documents with applicable jurisdictions, categories, and related documents; and (iv) to track all changes or modifications made to documents, i.e. to maintain a document access and modification audit trail.

In one embodiment, a risk management system is provided in connection with a risk management intranet architecture. Under the intranet architecture, an internal web server or host such as host 12 of FIG. 1 is provided. In connection with host 12 is a database server. The compliance system intranet architecture includes two modules, the system manager and the document manager to manage the table based documentation that supports database associated with the database server. The system manager sets up the components of the search criteria that ultimately allows the compliance system user to retrieve “business standards” documents. It also provides the framework to enter documents into document manager.

The document manager is used by designated individuals to populate the document database. In one embodiment, legal professionals, such as attorneys prepare case summaries to be input into the databases. Actual document text is downloaded into the system through the document manager and document associations with jurisdictions, categories, keywords, related documents, and hyperlinks are created and managed using the document manager. The document manager also tracks the numerous steps of document creation workflow and reports each document's status within the workflow process.

Documents are organized within the document manager in the following four ways. First, documents are associated with a jurisdiction, which is a territory within which authority may be exercised and which generally corresponds to a geographical area. Second, documents have an associated document type. Document types include: (i) articles and publications; (ii) best practices and compliance programs; (iii) business standards; (iv) case law summaries; (v) compliance guides; (vi) document retention policies; (vii) frequently asked questions; (viii) laws and regulations; (ix) legal requirements and case summaries; (x) model policies, forms, and agreements; (xi) news; (xii) notices and postings; (xiii) training related documents; (xiv) finance services policies and procedures; and (xv) other policies and procedures. The third document type is “category,” which is the corporate responsibility area to which the document applies, e.g. Corporate Operations, Employment, and General Corporate Compliance. The fourth document type is document workflow, which represents the status of a document within the workflow process of entering the document and all the necessary linkages into the compliance system.

Within the document manager, document types are already present that were established using the system manager. These document types appear in a type field drop-down menu associated with an “add new document” menu option and dialog box associated with the document manager. Only those document types established in connection with the system manager program may be added as a new document.

A new document is added upon receipt of a Compliance Input Checklist, which contains the information necessary to add or edit a document within the document manager. The following five tabs are associated with input forms that receive information when a new document is added. A tab is associated with and is a means for selecting an input form. For convenience, a tab and its associated input form are referred to simply as “tab” herein. The Compliance Input Checklist determines which input is required in connection with each input form. The tabs include (i) title; (ii) text; (iii) jurisdictions; (iv) categories; and (v) commentary. In one embodiment, particular document types require specific input in the fields of the “title” tab. For example, in documents of the “article” type, a title is required, including, for example, alerts corresponding to particular compliance events in the compliance calendar.

Additional tabs may also be provided, including (i) hyperlinks; (ii) keywords; and (iii) related documents. The compliance input checklist designates which input is required for a particular document. In one embodiment, an “alerts” tab is also provided, including, for example, alerts corresponding to particular compliance events in the compliance calendar.

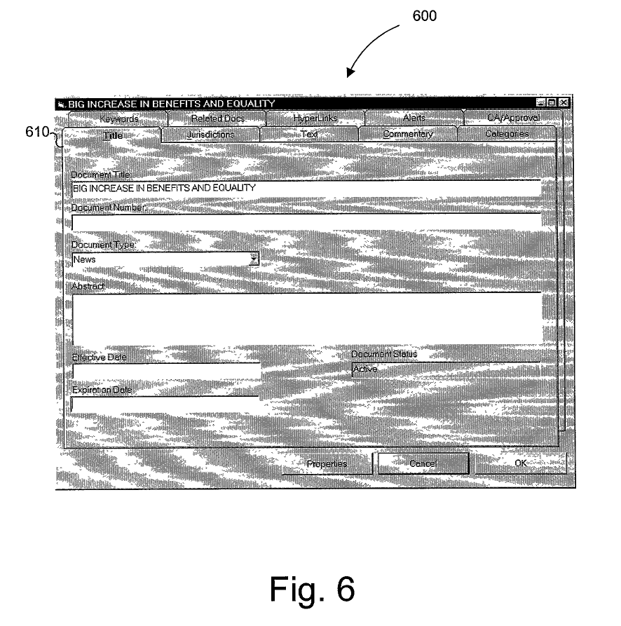

Referring now to FIG. 6, which is an exemplary and non-limiting screenshot associated with a risk management system consistent with the present invention, tabs are schematically represented. Dialog box 600 is an exemplary input dialog box used to receive information about documents. Tabs, such as exemplary tab 610 can be selected by clicking on, by way of a mouse or other pointing device, the desired tab. For example, for a user to have access to the input form associated with the text tab, the user would click on the text tab in dialog box 600.

In one embodiment, creating a new document with a title that is already in the documents database is not allowed. If a user attempts to create a document having the same name as a document already in the system, the user will receive an error message indicating that, in order to add the document, the document's title will need to be changed.

In one embodiment, the document manager does not recognize tab stops or bullet points or allow formatting of text. Templates are provided that allow source data to be manually re-formatted prior to input into the document manager. In one embodiment, if the compliance system is being used exclusively internally to an organization, Compliance Checklists, a list of frequently asked questions (“FAQ”), and important term templates are used exclusively by internal users.

Once a document has been added to the document manager, an interface called the document form is completed to finalize the document creation process and to make the document available to others. The document form contains several tabs, which, in one embodiment, include required tabs based on document type. The compliance input checklist indicates which tabs are required for a particular document type. In this process, additional detailed information is added to the document using the document form. This ensures that the document is placed correctly in the risk management system database and linked to the proper categories, related documents, and jurisdictions.

The status of a document (active or deleted) optionally appears on the “title” tab, in connection with the abstract text box. A document may be undeleted in the following ways: (i) by selecting the document and clicking an “undelete” icon on the document manager toolbar; or (ii) by changing data on any tab of the document form and clicking the “OK” button—even if no changes are necessary. For example, if a user does not need to change any data on a form, a field can be selected and retyped. After the “OK” button is pressed, the document is undeleted.

To save or cancel changes made to the document form, the user clicks the “OK” button associated with the input form. Alternatively, the user can select the “Cancel” button, which will cause any changes to the information to be discarded.

With respect to more specific information about an embodiment, the title tab contains information about the document, including its title, number, and type, and any applicable abstract text. The jurisdictions tab is used to link the document to appropriate jurisdictions. The text tab houses text corresponding to the text of the document. The commentary tab is associated with business standards and training documents and contains comments regarding the subject matter of the document or its intended audience. The category tab links a document to appropriate categories. The keywords tab receives keywords applicable to the document to facilitate keyword searches. The related documents tab links the new document to other applicable documents in the database. The hyperlinks tab links the document to other applicable web pages either on the Internet or on an intranet associated with the risk management system. The quality assurance and approval (“QA”) tab tracks the workflow and quality approval process with associated document creation. It also contains checkboxes that release the document to internal users and to outside users.

The following describes an exemplary embodiment of input forms associated with various tabs. The title tab contains (i) the document title; (ii) a document number, such as a statute number for a laws and regulations type document, or a category name for business standards documents; (iii) the document type; (iv) an abstract of the document; (v) the effective date of the document, typically associated with news flashes and articles or publications; (vi) the document's expiration date. The jurisdictions tab includes the country, states, and/or provinces to which the document applies. The text tab allows document text to be typed in free-form or pasted from an existing document, such as a Word document. The commentary tab contains commentary information on the document. The categories tab receives information regarding the business areas to which the document applies, for example corporate operations, employment, or general corporate compliance. The keywords tab receives keywords that are assigned to a document to facilitate identifying the document by way of a keyword search. The related documents tab receives information regarding other documents within the risk management system databases that are related to a particular document. The hyperlinks tab is associated with URL links to related documents that reside outside the risk management system.

The QA tab receives information regarding several actions including workflow steps that must be completed prior to the associated document being made available for searching and reading in the risk management system. There is also a release to production checkbox. Checking the box allows the document to become available from within the risk management system. The release for external view checkbox enables a user to specify whether a particular document is to be made available outside of a particular scope.

In one embodiment, the process of adding a new document involves several stages. First, a user verifies the correctness of the document title and document type as automatically populated from the add new document dialog box. Next, an appropriate document number is provided in the document number field. It is understood that document numbers can be provided in other ways, for example, by automatic generation of random or pseudo-random numbers or strings. Next, text associated with a document abstract is provided into an abstract text input region. Next, an effective date is provided, and an expiration date is optionally provided.

In one embodiment, the jurisdiction tab receives information corresponding to jurisdictional associations of the documents. Specific document types can be established, using the system manager, that are jurisdiction independent, meaning that documents associated with a particular jurisdiction will also be associated with the parent jurisdiction. For example, if a document is associated with the jurisdiction “Alabama” and the particular document type is specified as jurisdiction independent, then the document will also be associated with the jurisdiction “U.S. Federal/All States” as well as “Alabama.”

In connection with the text tab, the actual text of a document is provided to the document manager. The provided text is visible and available to a user after performing a search that yields the particular document on the risk management system. Text can be provided free-form or pasted from an existing document. In one embodiment, the commentary tab receives a description of an appropriate audience for a particular document.

The categories tab is used to assign the appropriate risk areas to a document. A risk area represents the business area(s) to which the document applies. Keywords, related documents, and hyperlinks are provided in a manner similar to the manner in which categories are specified.

The QA tab optionally provides various workflow steps that are completed when adding a new document. First, the document form is reviewed to ensure all workflow steps have been finished. To that end, the following aspects are considered: (i) whether the document text is complete; (ii) whether the commentary text is complete; (iii) whether linking (or document associations) are complete, including whether all jurisdictions, categories, keywords, and related documents have been associated with the particular document; and (iv) whether the QA check is complete. Next, the check box for releasing the document internally is optionally selected. Further, the check box associated with releasing the document to external users is optionally selected.

Additionally, the document manager provides audit trail functionality according to which it provides a record of modifications to individual documents or to document properties, such as associations with related documents. In connection with the audit trail functionality is an audit trail viewer module.

To provide audit functionality, the document manager database tracks the properties of each document, providing a record of all changes made to that document. The changes can be viewed to review and analyze changes made to a document over time and to determine who made particular changes. A documents properties can be viewed by: (i) selecting a view properties icon from the document manager toolbar; (ii) selecting “document properties” from the view menu; or (iii) by right clicking on a document and selecting “properties.”

The document properties window displays two tabs: (i) “general” and (ii) “audit.” The “general” tab lists the document's number, title, and type. The “audit” tab provides a chronological listing of the activity in connection with a particular document. Information collected in connection with activities performed on the document include: (i) the date the activity took place; (ii) the type of modification, e.g. created, added, modified, or removed; (iii) a description of any change made to the document; and (iv) a user identifier associated with the user performing the activity on the document.

The audit trail viewer provides a chronological listing of all changes made to any documents over a specified time period, such as the last week. Information including the following information is provided in connection with the audit trail viewer: (i) the date the change was made to the document; (ii) the document type of the corresponding document; (iii) the document number of the corresponding document; (iv) the document name; (v) the type of modification; (vi) a description of any changes made to the document text or other properties; and (vii) an identification of the user associated with the change.

Additionally, the document manager provides tools for managing documents. Functions performed by the tools include (i) duplication of existing documents; (ii) reassignment of existing documents; (iii) search and replacement of text in selected tabs; (iv) identification of word frequency in specified text regions; (v) keyword management; and (vi) an ability to view alternate keywords.

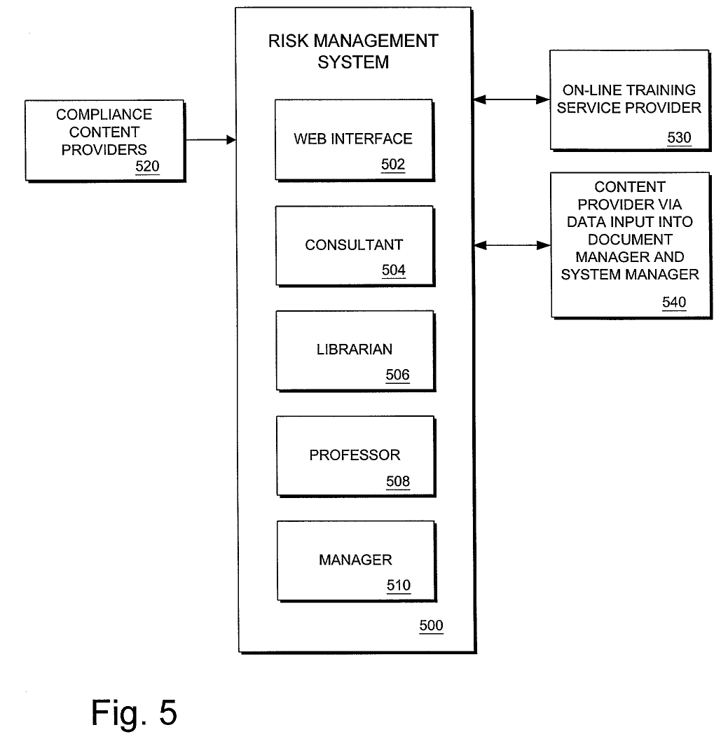

FIG. 5 is a schematic block diagram illustrating connections between a risk management system and external information providers and information receivers. The compliance system 500 includes various components, including a web interface 502, a consultant module 504, a librarian module 506, a professor module 508, and a manager module 510. Compliance content providers 520 provide compliance content to databases (not shown) associated with the compliance system 500. In one embodiment, the compliance content providers provide pre-categorized documents to the compliance system 500 by way of a batch loading interface. In this embodiment, the content is provided on a computer readable medium such as magnetic tape or CD-R media. The compliance system 500 batch loads compliance content from compliance content provider 520.

In an embodiment, the on-line training service provider 530 integrates its training programs into the compliance system 500, such that if a user of the compliance system 500 indicates an interest in receiving additional training in the areas of courses offered by the on-line training service provider 530 the user will be provided with an opportunity to receive training from the on-line training service provider 530. Further, assessments or tests associated with the manager module 510 indicate a need for additional training in connection with on-line training service provider 530 when users of the compliance system 500 complete an assessment having a score below a certain threshold.

In one embodiment, a content provider inputs data directly into the databases of the compliance system 500 as indicated in block 540. One example of this would be for an outside attorney, providing case summaries corresponding to newly decided legal opinions from courts of an arbitrary jurisdiction. In this example, the attorney summarizes a case and then inputs the case summary into the compliance system as a document of document type case summary.

The web interface 502 is provided by pages formatted in formats compatible with conventional browsers, such as the Hypertext Markup Language (“HTML”). HTML and other data in other formats are provided to browsers by way of a web server (not shown) associated with the web interface 502.

The consultant 504 is an interface that provides custom compliance information to users of the compliance system, and it optionally provides a toll free telephone number for reporting important compliance events. The consultant 504 also has the ability to provide technical user support to help in using the compliance system. Further, the consultant 504 is used to perform sophisticated natural language searches of the information stored in connection with compliance system 500. In one embodiment, consultant 504 comprises several elements. One element is individual consulting, comprising on-line questions and information retrieval or resource direction. It also includes on-line consumer specific consulting. Further, toll-free telephone services are accessed by risk management system users to address concerns with corporate policies or activities or to report violations, such as, for example, an instance unlawful disposal of hazardous materials. The consultant module is analogous to an industry specific legal PPO network, so that users of the system have the ability to receive the type of advice necessary to comply with applicable regulations and still be able to operate a business.

Another element relates to an on-line compliance response center, the compliance response center having several elements. The response center supports all on-line consulting features and further includes help desk functions to help users with technical questions or problems regarding the use of the risk management system. The response center further comprises on-line personalized consulting for particular program implementations.

In one embodiment, the distributed risk management system is used internally to a particular business. In this embodiment, the components contain information specific to the predetermined business's internal policies and procedures. In addition the library components also have links to a professor module and a news flash section that may contain recent information, such as recent court decisions, indictments, and news-paper articles.

In one embodiment, an additional module is provided. The module is called the associate module, and it provides record keeping, calendaring, and document management. The elements of the associate module include customized document management services, including the ability to map individual policies to risks, issues and standards and to provide customized information storage and retrieval. The compliance calendar is available to a business owner, managers, supervisors, and employees. Further there is a calendar for a risk management or compliance officer. The associate module also provides for record keeping and includes effective dates for particular laws or regulations, expiration dates, and optional E-mail reminder notices.

It is understood that the distributed risk management system, computer program and method of the present invention together provide a comprehensive, on-line source of risk management and compliance information that permits businesses to more effectively manage their risks with non-complaint business activities. The present invention permits businesses to identify potential liabilities, evaluate current procedures in dealing with such risks, implement recommended risk management procedures, and validate that the recommended procedures have in fact been implemented and are effective.

Although the invention has been described with reference to the preferred embodiment illustrated in the attached drawing figures, it is noted that equivalents may be employed and substitutions made without departing from the scope of the invention as recited in the claims.

Having thus described the preferred embodiment of the invention, what is claimed as new and desired to be protected by Letters Patent includes the following:

1. A computer program stored on a computer-readable memory device for controlling operations of a host computer, the computer program comprising:
instructions operable to access at least one database of information relating to loss prevention issues;
instructions operable to enable a plurality of users to access the host computer via a communications network;
instructions operable to receive from the users at least one request for information relating to loss prevention issues;
instructions operable to respond to information requests by accessing the database to locate the requested information;
instructions operable to administer a test to a user, the test including a plurality of test questions relating to loss prevention issues, the test prompting the user to provide answers to the test questions;
instructions operable to access correct answers to the test questions;
instructions operable to compare the answers given by the user to the correct answers;
instructions operable to access recommended procedures relating to each of the test questions; and
instructions operable to provide to the user, for each of the test questions that were answered incorrectly, the recommended procedures that relate to the test questions that were answered incorrectly.

2. The computer program as set forth in claim 1, the loss prevention issues including at least one of the following: sexual harassment issues, discriminatory hiring and firing issues, environmental issues, workplace safety issues, disability issues, tax issues, antitrust issues, securities issues, insider trading issues, hazardous materials issues, truth-in-lending issues, personal injury issues, and officer/director liability issues.

3. The computer program as set forth in claim 1, further including instructions operable to receive verification from the user that the user has implemented the recommended procedures.

4. The computer program as set forth in claim 3, further including a code segment operable to track which users have taken the test, test results for each of the users, and whether each of the users has implemented the recommended procedures, and to generate tracking information relating thereto.

5. The computer program as set forth in claim 4, further including instructions operable to enable an administrator to access the tracking information to validate compliance with the recommended procedures.

6. The computer program as set forth in claim 1, the communications network being a network selected from the group consisting of an Internet, a local area network, a wide area network, an intranet, and an extranet.

7. The computer program as set forth in claim 1, the information stored in the database including at least one of the following: loss prevention articles, frequently asked questions, loss prevention standards, loss prevention best practices, applicable laws, and loss prevention tips.

8. An on-line web-based risk management system for providing loss prevention information to users, the system comprising:
a host computer; and
a computer program stored on a computer-readable memory device accessible by the host computer for controlling operations of the host computer, the computer program including:
instructions operable to access at least one database of information relating to loss prevention issues;
instructions operable to enable the users to access the host computer via a communications network;
instructions operable to enable the users to request information relating to loss prevention issues;
instructions operable to respond to information requests by accessing the database to locate the requested information;
instructions operable to administer a test to a user, the test including a plurality of test questions relating to loss prevention issues, the test prompting the user to provide answers to the test questions;
instructions operable to access correct answers to the test questions;
instructions operable to compare the answers given by the user to the correct answers;
instructions operable to access recommended procedures relating to each of the test questions; and
instructions operable to provide to the user, for each of the test questions that were answered incorrectly, the recommended procedures that relate to the test questions that were answered incorrectly.

9. The system as set forth in claim 8, the loss prevention issues including at least one of the following: sexual harassment issues, discriminatory hiring and firing issues, environmental issues, workplace safety issues, disability issues, tax issues, antitrust issues, securities issues, insider trading issues, hazardous materials issues, truth-in-lending issues, personal injury issues, and officer/director liability issues.

10. The system as set forth in claim 8, the computer program further including instructions operable to receive verification from the user that the user has implemented the recommended procedures.

11. The system as set forth in claim 10, the computer program further including instructions operable to track which of the users have taken the test, test results for each of the users, whether each of the users has implemented the recommended procedures, and to generate tracking information relating thereto.

12. The system as set forth in claim 11, the computer program further including instructions operable to enable an administrator to access the tracking information to validate compliance with the recommended procedures.

13. The system as set forth in claim 8, the communications network being a network selected from the group consisting of an Internet, a local area network, a wide area network, an intranet, and an extranet.

14. The system as set forth in claim 8, the information stored in the database including at least one of the following: loss prevention articles, frequently asked questions, loss prevention standards, loss prevention best practices, applicable laws, and loss prevention tips.

15. A method of providing information relating to risk management issues to at least one user, the method comprising:
providing a host computer that may be accessed by at least one user computer via a communications network;
enabling the user to access the host computer via the user computer;
enabling the user to request information from the host computer relating to loss prevention issues;
in response to the user requests, providing requested information to the user;
administering a test to the user via the host computer and the user computer, the test including a plurality of test questions relating to loss prevention issues;
prompting the user to provide answers to the test questions;
accessing with the host computer correct answers to the test questions;
comparing with the host computer the answers given by the user to the correct answers; and
providing to the user, via the host computer and the user computer, recommended procedures that relate to the test questions that were answered incorrectly by the user.

16. The method as set forth in claim 15, the loss prevention issues including at least one of the following: sexual harassment issues, discriminatory hiring and firing issues, environmental issues, workplace safety issues, disability issues, tax issues, antitrust issues, securities issues, insider trading issues, hazardous materials issues, truth-in-lending issues, personal injury issues, and officer/director liability issues.

17. The method as set forth in claim 15, the communications network being a network selected from the group consisting of an Internet, a local area network, a wide area network, an intranet, and an extranet.

18. A computer program stored on a computer-readable memory device for controlling operations of a host computer, the computer program comprising:
instructions operable to receive compliance information, the compliance information including legal requirements;
instructions operable to present assessment questions to facilitate conducting business activities in a manner compatible with the compliance information; and
instructions operable to associate compliance dates by which at least one compliance action must be taken to comply with the legal requirements.

19. The computer program as set forth in claim 18, wherein scheduling of the compliance dates is automatic.

20. The computer program as set forth in claim 18 further comprising instructions operable to present the assessment questions and to receive answers to the assessment questions, whereby a level of compliance understanding is measured.

21. The computer program as set forth in claim 20, wherein the assessment questions are based on at least one assessment template.

22. The computer program as set forth in claim 20, wherein the level of compliance understanding is evaluated by compliance personnel designated by a chief compliance officer who is designated by a corporate board of directors.

23. The computer program as set forth in claim 22, wherein the compliance personnel responsible for compliance evaluations have sufficient organizational freedom to identify and evaluate law compliance problems and to initiate, recommend, or provide solutions to any of the law compliance problems.

24. The computer program as set forth in claim 18, the compliance information including at least one of the group consisting of: sexual harassment issues, discriminatory hiring and firing issues, environmental issues, workplace safety issues, disability issues, tax issues, antitrust issues, securities issues, insider trading issues, hazardous materials issues, truth-in-lending issues, personal injury issues, and officer or director liability issues.

25. The computer program as set forth in claim 18, further including instructions operable to receive an indication from at least one user in a plurality of users that the user has implemented recommended procedures.

26. The computer program as set forth in claim 25, further including instructions operable to receive test information regarding the users that have taken a test and to provide user information relating thereto.

27. The computer program as set forth in claim 26, further including instructions operable to enable an administrator to access the test information to assess whether procedures recommended in connection with the test are being implemented.

28. An on-line web-based risk management system for providing loss prevention information to users, the risk management system comprising:
a host computer; and
a computer program stored on a computer-readable memory device accessible by the host computer for controlling operations of the host computer, the computer program including:
means for accessing at least one database including information relating to loss prevention issues;
means for providing a plurality of users with access the host computer via a communications network;
means for providing a query interface to the users to perform at least one query on the information relating to loss prevention issues;
means for providing a response to the query by accessing the database and locating any responsive information corresponding to the query;
means for administering a test to a user, the test including at least one test question relating to loss prevention issues and receiving user answers to the test question;
means for accessing appropriate answers to the at least one test question;
means for comparing the user answers given by the user to the appropriate answers;
means for accessing recommended procedures relating to the test question; and
means for providing to the user the recommended procedures that relate to the test question if the test question was answered incorrectly.

29. The system as set forth in claim 28, the computer program further comprising means for receiving verification from the user that the user has implemented the recommended procedures.

30. The system as set forth in claim 29, the computer program further comprising means for determining which of the users have taken the test, test results for each of the users, whether each of the users has implemented the recommended procedures, and to generate tracking information relating thereto.

31. The system as set forth in claim 30, the computer program further including means for authorizing an administrator to access the tracking information to validate compliance with the recommended procedures.
